(19) United States
(12) Patent Application Publication
(10) Pub. No.: US 2010/0129620 A1
(43) Pub. Date: May 27, 2010

(54) APPARATUS AND METHOD FOR PRINTING ON A MATERIAL FOR USE IN ABSORBENT ARTICLES

(75) Inventors: Xavier Lopez-Mas, Havertown, PA (US); Joshua Carney, Philadelphia, PA (US); Kenneth C. Sheets, Wolcottville, IN (US)

Correspondence Address: DRINKER BIDDLE & REATH (DC), 1500 K STREET, N.W., SUITE 1100, WASHINGTON, DC, 20005-1209, US

(73) Assignee: SCA HYGIENE PRODUCTS AB, Goteborg (SE)

(21) Appl. No.: 12/277,394

(22) Filed: Nov. 25, 2008

(51) Int. Cl. B32B 3/10; B65H 20/02

(52) U.S. Cl. 428/201; 226/1; 226/181

(57) ABSTRACT

A method and apparatus for printing graphics on a material used for various parts of absorbent articles. A continuous web of material is fed between a print roller and an impression roller in a machine direction. The print roller includes a plurality of parallel bars oriented in a cross direction, where the bars are oriented at an offset angle so as to be inclined relative to an axis parallel to the cross direction of the material.

### FIELD OF THE INVENTION

The present invention relates to an apparatus and method for printing on a material for use in absorbent articles. More particularly, the present invention relates to an apparatus and method for printing on a nonwoven material for use on various parts of an absorbent article.

### BACKGROUND OF THE INVENTION

Absorbent articles for absorption of body fluids are available in a number of different designs. For absorption of urine and excrement, use is generally made of diapers or incontinence guards with a shape which, during use, simulates a pair of briefs. There are other types of absorbent articles, such as feminine hygiene products. These products typically include a topsheet facing the body of the user, a backsheet facing the garment of a user, and an absorbent layer sandwiched between the inner, topsheet and outer, backsheet. To increase the aesthetics and functionality of the particular article, graphics may be printed on various portions of the article.

The topsheet and backsheet of the absorbent article may be made from a nonwoven material. Printing is typically applied to the particular nonwoven layer prior to attaching it to the other layers of the absorbent article. One example of printing is by way of a flexographic printing press machine. However, other types of printing include, but are not limited to, inkjet printing, gravure, offset lithography, screen printing, and the like. In a typical printing configuration, a master roll of nonwoven material is fed between a print roller and an impression roller. Adjacent to the print roller is an anilox roller, which feeds ink from the ink cavity onto the print roller. Upon rotation of the anilox roller and print roller, ink is transferred to the print roller. Depending on the design of the print roller, a particular graphic is printed onto the nonwoven material when it is fed between the print roller and anilox roller.

For example, graphics may be printed on the backsheet to simulate stripes, as in a pair of briefs. Stripes can also be printed on other parts of the absorbent article, such as the topsheet, core, leg cuff, waist feature, fastening system, landing zone, a side panel, a pocket, a spacer, or combinations thereof. In this case, the print roller includes a plate or sleeve including a plurality of parallel, horizontal bars or rectangles that are disposed about the circumference of the print roller. The bars extends in a cross direction, i.e., a direction perpendicular to a machine direction of the nonwoven material. When ink is transferred to the print roller and onto the bars, a stripe pattern is printed on the nonwoven material.

However, a number of drawbacks have occurred. In particular, the orientation of the bars having gaps disposed therebetween in a cross direction cause the roller to lose contact with the nonwoven material. As such, vibration or “press bounce” has occurred, thereby negatively affecting the through put of the printed nonwoven fabric. In addition, the print quality of the stripes are faded, and often times do not form complete rectangles. Finally, the nonwoven material may have ink strikethrough, thereby contaminating the print roller.

Accordingly, there is a need in the art to provide an improved apparatus and process that eliminates the problems associated with printing stripes on various parts of an absorbent article or garment.

### SUMMARY

According to a first aspect of the invention, a method for printing graphics on a layer of material comprises providing a continuous web of material, feeding the material between a print roller and an impression roller in a machine direction, wherein the print roller comprises a plurality of parallel bars oriented in a cross direction, said bars being oriented at an offset angle so as to be inclined relative to an axis parallel to the cross direction of the material.

According to a second aspect of the invention, an apparatus for printing graphics on a layer of material comprises a master roll including a web of continuous material, an ink cavity for supply rink an anilox roller for carrying ink to a print roller, an impression roller disposed adjacent to the print roller so that the continuous web of material is fed therebetween, wherein the print roller includes a plurality of parallel bars oriented in a cross direction, said bars being oriented at an offset angle so as to be inclined relative to an axis parallel to the cross direction of the material.

According to a third aspect of the present invention, an absorbent article includes a topsheet, backsheet, and an absorbent core disposed therebetween, wherein a portion of the absorbent article include plurality of parallel printed stripes that are slightly offset from a longitudinal axis of the absorbent article.

### BRIEF DESCRIPTION OF THE DRAWINGS

The accompanying drawings provide visual representations which will be used to more fully describe the representative embodiments disclosed herein and can be used by those skilled in the art to better understand them and their inherent advantages. In these drawings, like reference numerals identify corresponding elements.

FIG. 1 is a schematic of a processing line for the printing of a continuous web of material.

FIG. 2 is a perspective view of the web being fed between the print roller and impression roller according to the features of the present invention.

FIG. 3 is a top plan view of a portion of the material layer with the printed graphics according to the features of the present invention.

FIG. 4 is a perspective view of an absorbent article including the material layer made in accordance with the present invention, wherein the material layer is applied to the article in a cross machine direction.

FIG. 5 is a top plan view of the material layer of the absorbent article of FIG. 4 made in accordance with the present invention.

FIG. 6 is a perspective view of an absorbent article including the material layer made in accordance with the present invention, where the material layers are applied to the article in the machine direction.

### DETAILED DESCRIPTION OF THE PREFERRED EMBODIMENTS

A process and apparatus for printing a graphic design on a portion of an absorbent article or garment will be described in more detail. For example, various parts of the absorbent article may include a graphic design, such as the backsheet, topsheet, core, leg cuff, waist feature, fastening system, landing zone, side panel, handle, fastening tab, pocket, spacer, or combinations thereof. In the preferred embodiment, printing a graphic on a nonwoven material to be used in the production of the absorbent article is described. However, it should be understood that various other types of materials may be printed upon and used in the absorbent article or garment, such as polyethylene (PE) film, and the like.

An absorbent article or garment is defined as an article or garment used for the absorption of body fluids, including but not limited to, infant diapers and training pants, adult incontinence products, feminine hygiene products, gender specific absorbent products, and pet training absorbent articles. However, an absorbent article may also include, but is not limited to, other types of products, such as household, medical products, or the like.

The term “nonwoven material” refers to any material produced from the binding of natural and/or synthetic fibers, such as those are spun-bonded, SMS (spun bond, melt blown spun bond), SSMS, SMMS, carded, hydroentangled, spun laced, ultrasonically welded, as well as nonwovens made out of nanofibers, polypropylene tow, and the like. However, other types of nonwoven material may be included, particularly those that may be applied as an inner or outer layer of an absorbent article or garment. Preferably, the nonwoven is in the range of 1-100 gsm (grams per square/meter). However, this range may be more or less, depending on application and design preference. While the preferred embodiment discusses printing in connection with a nonwoven material, other types of materials may be printed upon and used in the absorbent article and are considered to be within the scope of the present invention.

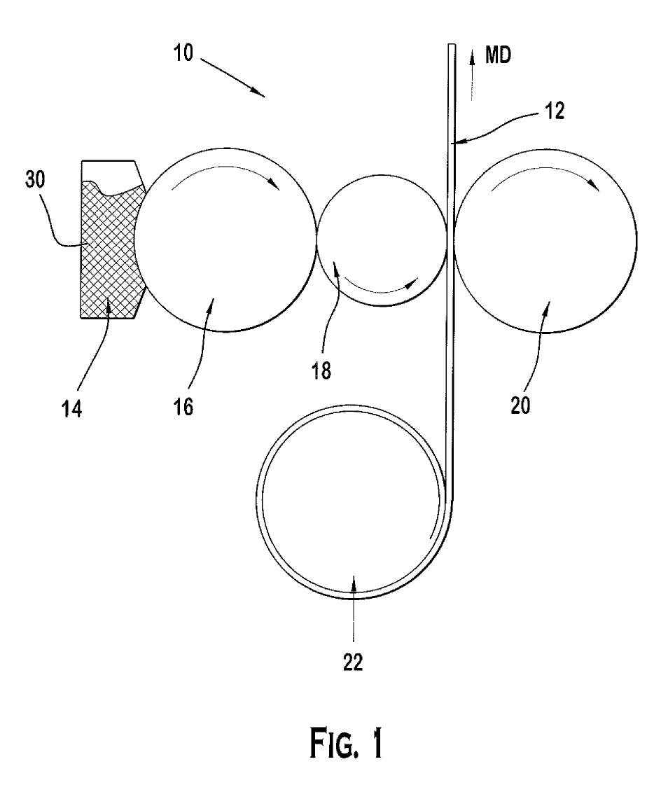

With reference to FIG. 1, the apparatus 10 for printing on a continuous web of nonwoven material 12 includes an ink reservoir 14, an anilox roller 16, a print roller 18, and an impression roller 20. The apparatus 10 is to be used in a typical flexographic printing process. However, other types of printing processes may also be used, such as ink jet printing, gravure, offset lithography, screen printing, and the like. Such processes may be chosen according to the type of material, application and design preferences.

Preferably, a single layer of nonwoven material is fed between a print roller 18 and an impression roller 20 from a master roll 22 of nonwoven material in a machine direction (MD). However, it should be understand that a multiple layer nonwoven material may be fed. In addition, it is also possible that other layers of an absorbent article or garment may be attached to the nonwoven material prior to the printing process.

In general, the anilox roller 16 rotates in a clockwise (CW) and carriers ink 30 from the ink reservoir 14 to the print roller 18. The print roller 18 is disposed adjacent to the anilox roller 16 and rotates in an counterclockwise direction (CCW). Ink 30 from the anilox roller 16 is transferred to protruding graphic design portions on the outer circumference of the print roller 18. The print roller 18 may include a removable sleeve, printing plate, or the like, for containing the particular design.

The impression roller 20, which rotates in a clockwise (CW) direction, is disposed adjacent to the print roller 18 and on the opposite side of the nonwoven material 12, such that the graphics on the print roller 18 are pressed against and printed on the web of nonwoven material 12. However, it should be understood that the rollers may rotate in the opposite direction, so long as the rollers are appropriately coordinated.

As described above, the print roller 18 may include various types of graphical designs to be printed on a nonwoven material. The present invention pertains to printing of stripes, or any other type of design having gaps along the counter direction of the print roller, causing press bounce. When printing stripes, a plurality of horizontal bars are disposed about an axis parallel to the rotational axis B of the print roller 18, and perpendicular to the machine direction of the nonwoven material. This causes numerous problems, as described above.

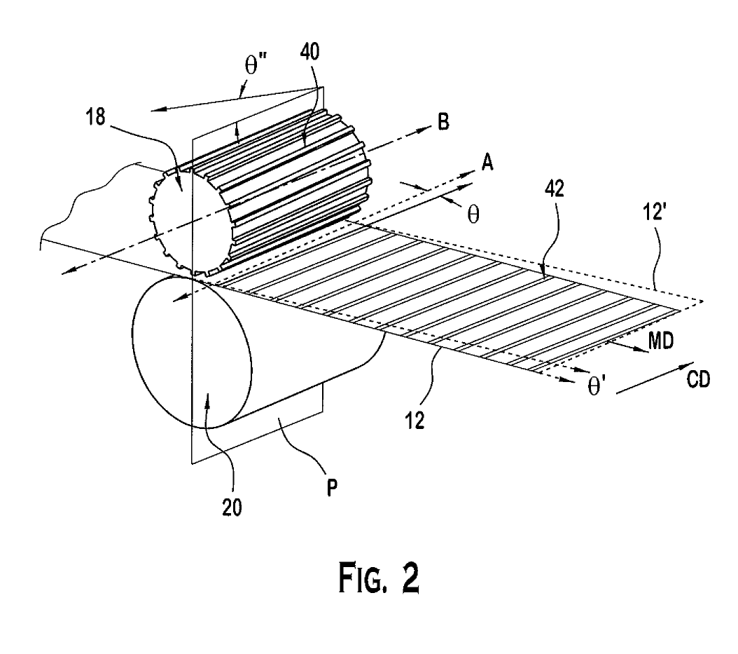

With reference to FIG. 2, details of the print roller 18 according to the preferred embodiment is described in more detail. In particular, the print roller 18 includes a plurality of printing bars 40 that are generally oriented in a cross direction (CD) of the feed or machine direction (MD) of the nonwoven material 12. However, the bars 40 are offset by an offset angle θ. The offset angle θ is defined as an angle in which bars 40 are inclined relative to an axis A parallel to the cross direction and perpendicular to the machine direction of the nonwoven material. The axis A is also horizontal and parallel to the rotational axis B of the print roller 18,

Accordingly, when a nonwoven material 12 is fed between the print roller 18 and the impression roller 20, the graphic design of stripes 42 is printed on the nonwoven material 12. As will be described in more detail with regard to the example below, the stripes 42 are slightly inclined or angled with respect to the cross direction. However, the appearance of the inclination is minimal. Nevertheless, to counteract the slight inclination, the nonwoven material 12′ may be fed at a counter offset angle θ′ substantially equal to the offset angle θ. As such, the inclination is counteracted, resulting in straight lines.

Alternatively, the print roller 18 may be rotated by an offset angle θ″ about plane P. In this regard, the printing bars 40 may be offset to the same degree in a direction counter to the angle in which the plane is rotated. In this example, the offset angle θ may range from between 0 to 45°. In addition, the nonwoven 12′ may be adjusted by offset angle θ′ in a counter direction to offset angle θ. Again, the offset angle θ′ may range from between 0 to 45°.

The printing bars 40 may be spaced equally around the circumference of the print roller, or may be spaced intermittently, depending on application and design preference. In addition, the printing bars 40 may be various widths, depending on application and design preference. When varying the widths of the printing bars, the nonwoven will have stripes with varying widths.

### EXAMPLE 1

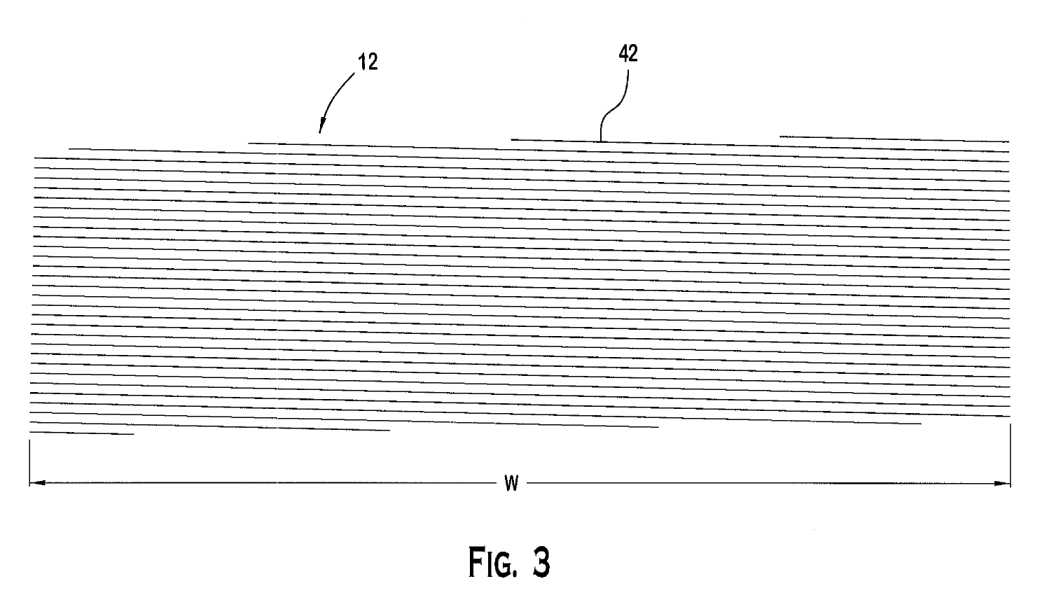

With reference to FIG. 3, one example of a nonwoven layer with the printed graphics 42 according to the features of the present invention is shown. The printed graphics 42 correspond to the configuration of the print roller 18. In accordance with the example shown in FIG. 3, a nonwoven layer 12 has a print width W of approximately 89.95″. The print width is centered on a 92.00″ print sleeve or plate. The bars 40 were angled at about a 2.2° offset angle, and disposed 29 times about the circumference of the print roller 18. The bars were about 0.20″ and spaced apart by between about 0.80″ and 0.85″.

The particular dimensions described above allow for the appearance of straight lines. Accordingly, the offset angle should be chosen upon consideration of the length of the stripes. For example, the longer the stripes, the larger the offset angle may be. The width of the stripes and spacing between stripes may also be considered.

When the printing bars are oriented parallel to the horizontal or cross direction, vibration occurred at 76.2 m/min. The vibration was amplified as the speed increased. In accordance with the features of the present invention, the speed of the process could be increased to about 106.7 m/min, thereby increasing the throughput by about 29%.

An important aspect of the present invention is that the offset angle of the bars helps the manufacturing process significantly, while the stripes still have the appearance of straight lines even though they are slightly inclined. Therefore, significant benefits are attained, while minimally affecting the aesthetic appearance of the outer layer of the absorbent article or garment. Accordingly, the particular dimensions of the master roll, bars, and spacing should be chosen in a way to balance these competing interests. In this regard, the offset angle may be chosen to be at least between 1-6°. As described above, if the nonwoven is fed at a counterangle, or the print roller 18 is rotated in a counterdirection, the offset angle can range from between 0 to 45°. However, this range can change according to application and design preference.

Similarly, the master roll 22 may have a width of between about 1.5 inches to about 300 inches. However, this range can change according to application and design preference, and should be determined in connection with an appropriate offset angle. The master roll 22 may be made of a single print sleeve or multiple print sleeves connected by bearing rings, or the like.

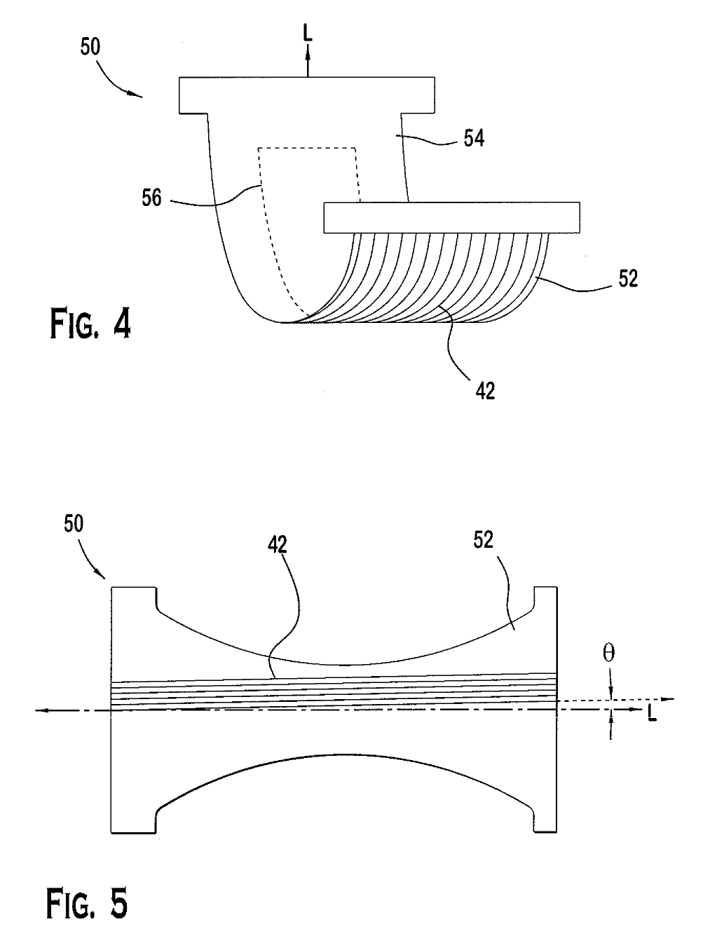

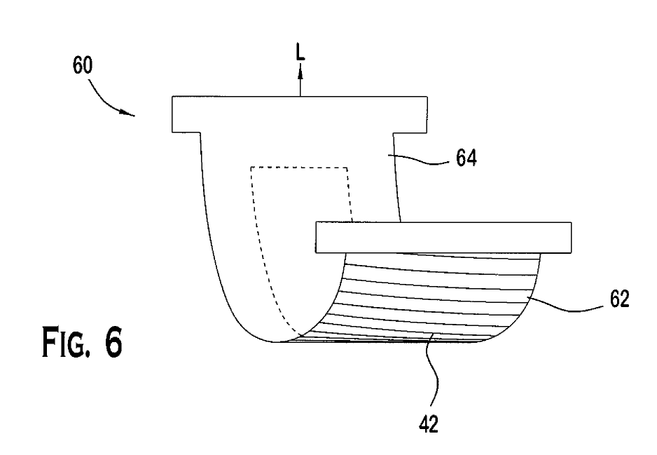

With reference to FIGS. 4 and 5, an absorbent article 50 is shown which includes a nonwoven backsheet 52 manufactured in accordance with the features of the present invention. In particular, the backsheet 52 is a nonwoven material including graphics or stripes 42 printed thereon. However, it should be understood that the printed nonwoven material may also be used for the topsheet, core, leg cuff, waist feature, fastening system, landing zone, side panel, handle, fastening tab, fastening belt, pocket, spacer or any other part of the hygiene product, and combinations thereof. In addition, the present invention is also applicable to other types of materials other than nonwoven products used in hygiene articles, such as polyethylene (PE) films, and the like.

The absorbent article 50 extends in a longitudinal direction L and also includes a topsheet 54, with an absorbent core 56 sandwiched between the backsheet 52 and topsheet 54. As discussed above, the stripes 42 may be applied to any type of absorbent article, such as diapers, training pants, adult incontinence guards, female hygiene products, gender specific incontinence products, and pet training absorbent articles. In addition, the stripes may be applied to any other type of material used for the various parts of the absorbent article.

As shown in FIG. 5, the outer layer 52 includes a plurality of parallel, printed stripes 42 that are slightly offset by an offset angle θ from a longitudinal axis L of the absorbent article 50. The nonwoven layer is applied to the article 50 in a cross machine direction. It should be noted that only a portion of the stripes 42 are shown for clarity so that the offset angle θ is more easily discerned. In particular, the offset angle θ may be chosen to be at least between 1-6°, and preferably around 2.2°. The particular offset angle may be chosen depending upon length or the stripes. Accordingly, an improved manufacturing process is attained, while maintaining the aesthetics of the striped, nonwoven outer layer.

As shown in FIG. 6, an absorbent article 60 includes a backsheet and topsheet 62 and 64, respectively, made in accordance with the present invention, where the layers are applied to the article 60 in the machine direction. However, it should be understood that the printed material may be applied to various parts of the absorbent article in any orientation, and combinations of orientations, depending on application and design preference.

Although the present invention has been described in connection with preferred embodiments thereof, it will be appreciated by those skilled in the art that additions, deletions, modifications, and substitutions not specifically described may be made without department from the spirit and scope of the invention as defined in the appended claims.

1. A method for printing graphics on a material for use in an absorbent article, comprising:
providing a continuous web of material;
feeding the material between a print roller and an impression roller in a machine direction, wherein the print roller comprises a plurality of parallel bars oriented in a cross direction, said bars being oriented at an offset angle so as to be inclined relative to an axis parallel to the cross direction of the material.

2. The method of claim 1, wherein the offset angle is about 2.2°.

3. The method of claim 1, wherein the offset angle is between about 1 to 6°.

4. The method of claim 1, wherein the offset angle is between about 0 to 45°.

5. The method of claim 1, wherein the continuous web of material is fed from a master roll.

6. The method of claim 5, wherein the master roll has a width of between 1.5 and 300 inches.

7. The method of claim 1, wherein the continuous web of material is fed at a counter offset angle substantially equal to the offset angle.

8. The method of claim 1, wherein the print roller is rotated and positioned at a counter offset angle substantially equal to the offset angle.

9. The method of claim 1, wherein the printed material is used for forming a part of the absorbent article selected from a group consisting of a topsheet, backsheet, core, leg cuff, waist feature, fastening system, landing zone, side panel, handle, fastening tab, fastening belt, pocket, spacer, or combinations thereof.

10. An apparatus for printing graphics on a nonwoven layer of material, comprising:
a master roll including a web of continuous material;
an ink cavity for supplying ink;
an anilox roller for carrying ink to a print roller;
an impression roller disposed adjacent to the print roller so that the continuous web of material is fed therebetween, wherein the print roller includes a plurality of parallel bars oriented in a cross direction, said bars being oriented at an offset angle so as to be inclined relative to an axis parallel to the cross direction of the material.

11. The apparatus of claim 10, wherein the offset angle is about 2.2°.

12. The apparatus of claim 10, wherein the offset angle is between about 1 to 6°.

13. The apparatus of claim 10, wherein the offset angle is between about 0 to 45°.

14. The apparatus of claim 10, wherein the continuous web of material is fed from a master roll.

15. The apparatus of claim 14, wherein the master roll has a width of between 1.5 and 300 inches.

16. The apparatus of claim 10, wherein the continuous web of material is fed at a counter offset angle substantially equal to the offset angle.

17. The apparatus of claim 10, wherein the print roller is rotated and positioned at a counter offset angle substantially equal to the offset angle.

18. The apparatus of claim 10, wherein the printed material is used for forming a part of tie absorbent article selected from a group consisting of a topsheet, backsheet, core, leg cuff, waist feature, fastening system, landing zone, side panel, handle, fastening tab, fastening belt, pocket, spacer, or combinations thereof.

19. An absorbent article, comprising:
a topsheet;
a backsheet; and
an absorbent core disposed therebetween, wherein a portion of the absorbent article include plurality of parallel printed stripes that are slightly offset from a longitudinal axis of the absorbent article.

20. The absorbent article of claim 19, wherein the stripes are offset by about 2.2°.

21. The absorbent article of claim 19, where the stripes are offset by between about 1 to 6°.

22. The absorbent article of claim 19, wherein the stripes are offset from and substantially parallel to a longitudinal axis of the article.

23. The article of claim 19, wherein the stripes are offset from an axis substantially perpendicular to longitudinal axis of the article.
